(19) United States
(12) Patent Application Publication
(10) Pub. No.: US 2025/0378677 A1
(43) Pub. Date: Dec. 11, 2025

(54) METHOD FOR PROVIDING A THREE-DIMENSIONAL FEATURE MAP OF A ROAD SURFACE

(71) Applicant: Robert Bosch GmbH, Stuttgart (DE)

(72) Inventors: Alexander Schoelles, Stuttgart (DE); Alexandru Paul Condurache, Renningen (DE); Joel Janai, Leonberg (DE); Maximilian Pittner, Erlangen (DE)

(21) Appl. No.: 19/223,161

(22) Filed: May 30, 2025

(30) Foreign Application Priority Data
Jun. 10, 2024 (DE) 10 2024 205 319.8

(51) Int. Cl. G06V 10/77; G06V 20/56; G06V 20/64

(52) U.S. Cl. CPC G06V 10/7715; G06V 20/588; G06V 20/64

(57) ABSTRACT

A method for providing a three-dimensional feature map of a road surface. A computer program, a device, and a storage medium are also described.

### CROSS REFERENCE

The present application claims the benefit under 35 U.S.C. § 119 of German Patent Application No. DE 10 2024 205 319.8 filed on Jun. 10, 2024, which is expressly incorporated herein by reference in its entirety.

### FIELD

The present invention relates to a method for providing a three-dimensional feature map of a road surface. The present invention also relates to a computer program, a device and a storage medium for this purpose.

### BACKGROUND INFORMATION

Deep learning-based methods for marking and traffic line detection can use architectures comprising two or more components. One component forms a neural network (backbone), for example, that is used for feature extraction, while the second component (detection head) can be used for the actual detection and geometry estimation of the markings and traffic lines from the extracted features. In the simplest case, the features can be learned and extracted directly from the input image in the camera perspective by the backbone and then processed by the detection head for detection. This basic architecture is used in particular for 2D line detection, because the learned image feature space is represented directly in the camera perspective in which the to-be-detected lines will also be modeled. A further component can be used primarily for 3D line detection-so-called inverse perspective mapping (IPM). IPM is in particular a homography-based transformation that is used to project image features from the plane of the camera perspective onto a flat ground plane. This ground plane should preferably reflect the geometry of the road surface. Since traffic line markings for 3D detection can be displayed in a 3D coordinate system determined by the course of the road surface, the image features should preferably be depicted in a feature space that is as similar to the road surface as possible.

Some methods use the IPM component to project the input image onto a flat ground plane. However, most 3D detection methods use the IPM component as an intermediate step between the backbone and the detection head, and project the features learned by the backbone onto the ground plane rather than projecting the image features directly. The detection head then processes the extracted features that were geometrically projected onto the ground plane to estimate the 3D geometry of the underlying lines.

One limitation of the existing methods is that inverse perspective mapping only describes a transformation from the image plane in the camera perspective to a flat ground plane. It is therefore implicitly assumed that the road surface corresponds to a flat world and therefore does not contain elevation profiles that deviate from the zero plane. If the assumption is incorrect, the feature space is less suitable for representing the scenario of the road environment. For scenarios with steep uphill slopes, it could therefore no longer be possible to represent certain features from the input image; whereas scenarios with steep downhill slopes comprise large areas that lack features useful for the detection task. Especially for the problem of 3D line detection, however, these elevation differences represent the interesting and important scenarios.

### SUMMARY

The present invention includes a method, a computer program, a device, and a computer-readable storage medium. Further features and details of the present invention will emerge from the disclosure herein. Features and details which are described in connection with the method according to the present invention will of course also apply in connection with the computer program according to the present invention, the device according to the present invention and the computer-readable storage medium according to the present invention and vice versa, so that mutual reference is always possible with respect to the disclosure of the present invention.

The present invention includes a method for providing a three-dimensional feature map of a road surface. According to an example embodiment of the present invention, the method comprises the following steps, wherein the steps can be carried out repeatedly and/or successively.

In a first step, a camera image is preferably provided, wherein the camera image includes a depiction of the road surface and results from acquisition by a camera. The camera image is in particular an image from a front camera perspective. In other words, the camera was in particular disposed on the front of a vehicle when the camera image was being acquired.

In a further step, features of the camera image are preferably extracted, wherein the extracted features are specific to the road surface. A machine learning model, in particular a backbone of the machine learning model, is preferably used for this purpose. The machine learning model, or the backbone of the machine learning model, is a convolutional neural network, for example, and can use its properties for feature extraction. Further layers can also be used here to generate a two-dimensional feature map, in which each two-dimensional point contains a multidimensional feature. This feature map corresponds in particular to the camera perspective from the front.

In a further step, a three-dimensional feature space is preferably defined, wherein the three-dimensional feature space comprises a large number of voxels. The three-dimensional feature space is in particular in the form of a cuboid grid. The three-dimensional feature space is preferably subtended over x-, y-, and z-coordinates and defined by a respective interval. A resolution can also be specified for each dimension of the three-dimensional feature space, so that a cuboid grid is created within the three-dimensional feature space. Each resulting voxel can be uniquely described using a three-dimensional spatial coordinate. A number of voxels is defined in particular by the respective intervals and resolutions. A voxel is in particular a three-dimensional pixel used to depict volume data.

In a further step, preferably at least three surface hypotheses for the road surface are determined in the three-dimensional feature space. The surface hypotheses are in particular differently oriented planes in the three-dimensional feature space which each represent possible courses for the road surface. The surface hypotheses can have any desired shape that can advantageously reflect a priori knowledge about typical road or road surface profiles. The surface hypotheses can include uphill slopes and downhill slopes and, in terms of number and orientation, can be defined as desired, wherein a higher number can provide a more precise depiction of the actual road surface.

In a further step, the extracted features are preferably projected onto the determined surface hypotheses. As part of this, it can be provided that each voxel is uniquely assigned a multidimensional feature that represents respective extracted features of the voxel, wherein every point on the surface hypotheses is associated with a multidimensional feature.

In a further step, intersection points of sight rays with the determined surface hypotheses are preferably calculated, wherein the sight rays extend from the camera through respective centers of all voxels of the large number of voxels. Preferably only the intersection points located inside the three-dimensional feature space are taken into consideration in the further process.

In a further step, respective extracted features are preferably assigned to the respective voxels, wherein the extracted feature assigned to the respective voxel results from a weighted sum of the extracted features projected onto the surface hypotheses, wherein weightings of the weighted sum correspond to a distance between a voxel center of the respective voxel and the calculated intersection points of the sight ray with the surface hypotheses. A large distance results in particular in a small weight. The weighted extracted features can be added along their sight ray to form a weighted multidimensional feature for the associated voxel. The respective weight of an intersection point can advantageously function as a balance between the geometric position of the extracted feature relative to the associated voxel and a feature quality of the intersection point.

In a further step, the three-dimensional feature map is preferably provided based on the assigned extracted features. There are a variety of options for providing the three-dimensional feature map. One option is to simply combine the features along a height dimension of the three-dimensional feature space. The weighted extracted features can be concatenated or accumulated, for example.

According to an example embodiment of the present invention, another option is to select the features from the three-dimensional feature space such that features are selected along the surface profile of the road surface. In a further step, a probability value is preferably determined for each voxel within a respective vertical voxel column based on the assigned extracted features of each voxel, wherein the probability value represents a probability that the road surface passes through the respective voxel.

According to an example embodiment of the present invention, the determination of the probability value can be implemented with a machine learning model, which is based on training using an implicit learning method (self-supervised) or also using an explicit learning method (supervised). For this purpose, each voxel column of the three-dimensional feature space can be viewed as a classification problem. For further processing, a single optimal voxel in each voxel column is preferably classified for the feature provision, wherein the height dimension of the three-dimensional feature space can be reduced to size 1. Minimizing a 3D detection cost function makes it possible to adjust weightings of the machine learning model during training such that the resulting probability distribution reflects the elevation profile of the true road surface. The road surface can thus be learned implicitly. For the calculation of the surface probability, the probability that the road surface passes through the respective voxel can be estimated for each voxel in a voxel column. This results in particular in a probability distribution along the elevation for each voxel column. Applying this classification to each voxel column in particular creates a new feature map with the dimensions of the xy-plane of the three-dimensional feature space that includes the most valuable features of the three-dimensional feature space corresponding to the surface profile. This feature map can then also be encoded by a coding block which can comprise multiple convolutional neural layers. The classification problem along the voxel columns can likewise be optimized by explicit supervised learning. An explicit cost function that is suitable for multiple classification is preferably set up for this purpose. This cost function in particular forms a part of an overall cost function that is minimized by the machine learning model over the course of training.

In a further step, a geometric representation of the road surface can be ascertained based on the determined probability values. The voxel with the highest probability value can be selected for each voxel column, for instance. The three-dimensional feature map can then be provided for the voxels of the geometric representation. The geometric representation can subsequently be used to detect traffic line markings, for example with a detection head of a machine learning model. It can also be provided that the extracted features are combined based on the ascertained probability values.

It is also possible that the method also comprises the following step:
calculating a second distance between each voxel and a next one of the at least three surface hypotheses, wherein the extracted features of each voxel are further weighted based on the calculated second distance.

This further weighting can also be referred to in the context of the present invention as geometric a priori weighting. The weight is calculated using the second distance, for example, which represents a minimum distance between a voxel along the respective sight ray and a surface hypothesis, wherein a distance of zero achieves the highest weight of 1. The smallest weight here, for instance, is the number 0.

In the context of the present invention, it can preferably be provided that projecting is carried out using a sampling grid and also using bilinear interpolation to obtain a feature for every point on the surface hypotheses. This can have the advantage that the accuracy of the surface reconstruction is improved, because the sampling grid can provide a higher resolution than the actual camera resolution. The use of bilinear interpolation can possibly also improve the quality of the features obtained for each point on the surface hypotheses. Combining these techniques makes it possible to provide a more precise and detailed geometric representation of the road surface.

Optionally, it is also possible that the method is used in a vehicle, wherein the vehicle comprises the camera, and the method further comprises the following steps:
initiating the acquisition of the camera image,
using the provided three-dimensional feature map for at least partially automated driving of the vehicle.

The road surface can thus advantageously be determined directly in the vehicle using the geometric representation, and subsequent processes, such as traffic line detection, can be carried out more precisely in order to improve the at least partially automated driving of the vehicle. The provided three-dimensional feature map can, for instance, be used in a system function of the vehicle such as a lane keeping assist system. The three-dimensional feature map can initially serve to improve the detection of traffic line markings, which can in turn be used for the surroundings perception of the vehicle for at least partially automated driving.

In the context of the present invention, it can also be advantageous that an origin of the three-dimensional feature space lies in a Cartesian reference coordinate system of the road surface depicted by the camera image, wherein the vertical voxel columns represent a height dimension in the three-dimensional feature space. The method according to the present invention can therefore advantageously take into account deviations in the elevation of the road surface, such as an uphill slope or a downhill slope, or even holes in the road surface. The reference coordinate system of the three-dimensional feature space is in particular a spatial depiction of the surroundings of the vehicle, wherein the vehicle, preferably a vehicle rear axle, describes the origin of this coordinate system. The camera image is in particular depicted in another coordinate system having an origin in the camera center and represents the road surface. The features from the camera image are preferably transferred to the three-dimensional feature space as part of the method according to the present invention, but the two coordinate systems are in particular not identical.

It is possible for the method according to the present invention to be used in a vehicle. The vehicle can be a motor vehicle and/or a passenger vehicle and/or an autonomous vehicle, for instance. The vehicle can comprise a vehicle device, for example for providing an autonomous driving function and/or a driver assistance system. The vehicle device can be configured to at least partially automatically control and/or accelerate and/or brake and/or steer the vehicle.

Another subject matter of the present invention is a computer program, in particular a computer program product, comprising instructions that, when the computer program is executed by a computer, prompt the computer program to carry out the method according to the present invention. The computer program according to the present invention has the same advantages as those described in detail with reference to a method according to the present invention.

The present invention also relates to a data processing device which is configured to carry out the method according to the present invention. The device can be a computer, for example, that executes the computer program according to the present invention. The computer can comprise at least one processor for executing the computer program. A non-volatile data memory can also be provided, in which the computer program can be stored and from which the computer program can be read by the processor for execution.

The present invention can also relate to a computer-readable storage medium, which comprises the computer program according to the present invention and/or instructions that, when executed by a computer, prompt the computer program to carry out the method according to the present invention. The storage medium is configured as a data memory such as a hard drive and/or a non-volatile memory and/or a memory card, for example. The storage medium can be integrated in the computer, for instance.

The method according to the present invention can moreover also be configured as a computer-implemented method. Alternatively or additionally, at least one of the disclosed method steps of the present invention can be computer-implemented and/or carried out automatically.

Further advantages, features, and details of the present invention will emerge from the following description, in which embodiment examples of the present invention are described in detail with reference to the figures. The features disclosed herein can each be essential to the present invention individually or in any combination.

### BRIEF DESCRIPTION OF THE DRAWINGS

FIG. 1 shows a schematic visualization of a method, a vehicle, a device, a storage medium and a computer program according to embodiment examples of the present invention.

FIG. 2 shows a schematic illustration of a three-dimensional feature space with surface hypotheses according to embodiment examples of the present invention.

FIG. 3 shows a schematic illustration of a three-dimensional feature space and a voxel column according to embodiment examples of the present invention.

### DETAILED DESCRIPTION OF EXAMPLE EMBODIMENTS

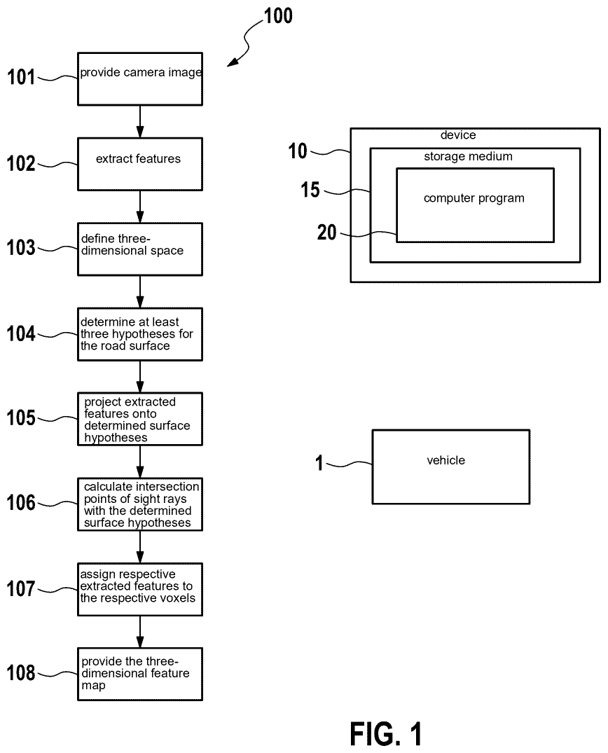

FIG. 1 schematically shows a method 100, a vehicle 1, a device 10, a storage medium 15 and a computer program 20 according to embodiment examples of the present invention.

FIG. 1 in particular shows a method 100 for determining a geometric representation of a road surface 5. In a first step 101, a camera image is provided, wherein the camera image includes a depiction of the road surface 5 and results from acquisition by a camera 2. In a second step 102, features of the camera image are extracted, wherein the extracted features are specific to the road surface 5. In a third step 103, a three-dimensional feature space 3 is defined, wherein the three-dimensional feature space 3 comprises a large number of voxels 4. In a fourth step 104, at least three surface hypotheses 6 for the road surface 5 are determined in the three-dimensional feature space 3. In a fifth step 105, the extracted features are projected onto the determined surface hypotheses 6. In a sixth step 106, intersection points 8 of sight rays 7 with the determined surface hypotheses 6 are calculated, wherein the sight rays 7 extend from the camera 2 through respective centers of all voxels 4 of the large number of voxels 4. In a seventh step 107, respective extracted features are assigned to the respective voxels 4, wherein the extracted feature assigned to the respective voxel 4 results from a weighted sum of the extracted features projected onto the surface hypotheses 6, wherein weightings of the weighted sum correspond to a distance between a voxel center of the respective voxel 4 and the calculated intersection points 8 of the sight ray 7 with the surface hypotheses 6. In an eighth step 108, the three-dimensional feature map is provided based on the assigned extracted features.

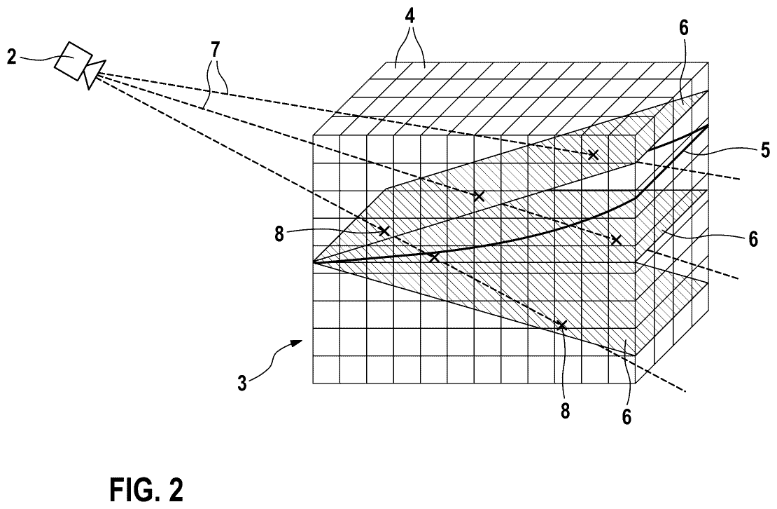

FIG. 2 schematically shows a three-dimensional feature space 3 with voxels 4. Three surface hypotheses 6 and a course of the actual road surface 5 are depicted in the feature space 3. Intersection points 8 of the sight rays 7 of the camera 2 with the surface hypotheses 6 are furthermore depicted as crosses.

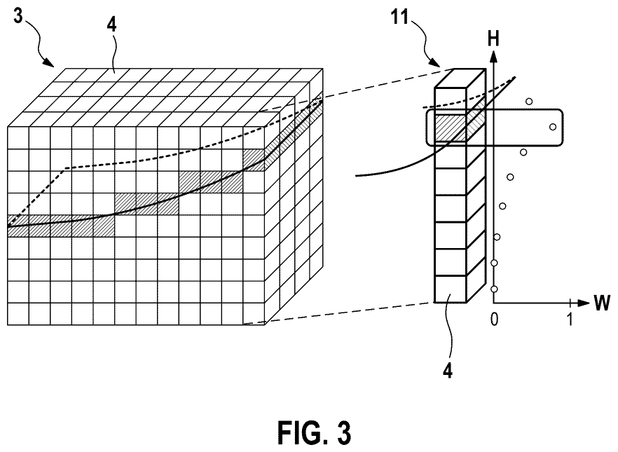

FIG. 3 shows a schematic illustration of a three-dimensional feature space 3 with a large number of voxels 4 and a voxel column 11. For the voxel column 11, a probability value W is determined along the height H for the respective voxels 4.

The present invention is in particular based on an approach for deep learning-based 3D detection of traffic line markings. The method is used, for instance, to improve existing methods for 3D line detection for surroundings perception for driver assistance systems (partially to fully automated driving functions). Since the present invention presented here is based on a camera-based detection method, at least one camera sensor is needed as the sensor, for example, which is mounted on the vehicle and directed toward the front during acquisition. The present method according to embodiment examples is generally not limited to a single camera sensor and can be expanded with little adjustment effort to allow the use of multiple camera sensors. For the sake of simplicity, only the case of using a single camera is described in the following.

The image data recorded by the camera are preferably processed by a computing unit on which the method according to embodiment examples can also be implemented as software. The present invention is in particular based on learning-based detection methods that use machine learning models, such as neural networks, for line detection. Since the neural networks used here can in particular be trained on (preferably large) data sets, image data recorded by a camera as described above may be required. Labels that are intended to describe a so-called true 3D geometry (ground truth) of the traffic lines visible in the respective image can also be provided for the image data. This description of the 3D geometry of an individual line instance can, for example, be realized as an ordered list of 3D point coordinates (polyline).

According to embodiment examples, the present invention describes a new component for machine learning models for traffic line detection for which the rarely applicable assumption of a flat road elevation profile does not have to be satisfied. The image feature representation corresponding to the ground plane is in particular replaced by a three-dimensional feature representation in which image features can be modeled and processed in a cuboid 3D voxel grid, i.e. the three-dimensional feature space. Instead of assuming a flat surface hypothesis, the surface, which can have any desired shape and can therefore include uphill slopes and downhill slopes, is preferably implicitly modeled in the three-dimensional feature space and used for the selection of features. A variety of surface hypotheses, which are intended to depict the space with a high probability of occurrence of the road or road surface and therefore the 3D traffic line markings, can be used for the projection of the image features into the three-dimensional feature space.

In summary, the present invention according to embodiment examples results, for instance, in the following advantages. Projecting and processing features in a three-dimensional feature space allows three-dimensional features to be learned, whereas feature projection onto a single flat surface only allows two-dimensional features to be learned. This three-dimensional feature representation makes it possible to learn the three-dimensional geometry of lines better than when using a two-dimensional feature representation. Using different surface hypotheses enables the use of a priori knowledge about the three-dimensional line geometry. Since the surface hypotheses can be modeled in such a way that a majority of the elevation profiles of the three-dimensional traffic lines can be approximated by them, the coarse surface geometry does not have to be learned explicitly from the data, for example. When projecting using IPM assuming a flat road surface, important image features are not represented in particular when the elevation profile of the to-be-learned traffic line marking includes uphill slopes. In the three-dimensional feature space, however, these uphill slopes can be represented by the upper voxels. On the other hand, important image features are represented in compressed form in particular only when the elevation profile of the to-be-learned lines includes downhill slopes. In the three-dimensional feature space, however, these downhill slopes can be represented by the lower voxels. Projecting image features into a three-dimensional feature space thus enables the space required for detection to be modeled in a geometrically meaningful manner. Implicitly modeling the road surface using a learned surface probability allows the three-dimensional feature space to become more interpretable, which makes it easier to understand the learning process of the machine learning model.

A first technical feature of the present invention according to embodiment examples consists of a cuboid 3D voxel grid, i.e. the three-dimensional feature space, which is fixedly defined via intervals and resolutions and is subtended in a Cartesian coordinate system of the road. Each voxel of the three-dimensional feature space is in particular defined by a unique 3D coordinate of the voxel center and preferably represents a multidimensional feature that can be used for three-dimensional traffic line detection. A second technical feature of the present invention according to embodiment examples consists of surface hypotheses which can have any shape and can include uphill slopes and downhill slopes and can be subtended within the three-dimensional feature space. The surface hypotheses are used for feature aggregation by means of projection of a feature map, for example, and thus form a feature basis for each individual voxel, wherein the feature proportion can be higher than in the case of projection by means of IPM. The third technical feature of the present invention according to embodiment examples is the modeling of a surface within the three-dimensional feature space using a surface probability as well as the method for learning this surface probability. Classifying the elevation along each voxel column of the three-dimensional feature space makes it possible to explicitly estimate the true road surface profile, which allows only valuable features can be used for further processing.

The overall architecture of the machine learning model can be described as a deep neural network with various processing components comprising multiple layers of a convolutional neural network. The entire machine learning model is end-to-end trainable and optimizable. The present invention relates in particular to a component for learning the three-dimensional (3D) features. The further components of the machine learning model include, for example, a backbone and a detection head that outputs traffic line markings in any representation (e.g. anchor-based or using continuous functions such as splines). According to embodiment examples, the present invention can be used in combination with any backbones, detection heads and line representations.

A camera image from the front camera perspective is used as the input to the method, for instance. This image is preferably further processed by a backbone. The backbone is a convolutional neural network, for example, and can use its properties for feature extraction. Further layers are thus preferably used to generate a two-dimensional (2D) feature map, in which each two-dimensional point contains a multidimensional feature. This feature map corresponds in particular to the camera perspective from the front.

In a next step, a three-dimensional feature space is preferably defined as a cuboid grid. The origin of the three-dimensional feature space is in particular in a Cartesian reference coordinate system of a traffic environment around the vehicle. The three-dimensional feature space is preferably subtended over x-, y-, and z-coordinates and defined by a respective interval. A resolution can also be specified for each dimension of the three-dimensional feature space, so that a cuboid grid is created within the three-dimensional feature space. Each resulting voxel can be uniquely described using a three-dimensional spatial coordinate. The number of voxels is defined in particular by the respective intervals and resolutions. Each voxel is preferably also uniquely assigned a multidimensional feature (feature vector), which can be used to learn 3D information during training. In particular, this creates a seamless connection between the feature and the 3D geometry. To be able to assign features to individual voxels, according to embodiment examples of the present invention, a number of surface hypotheses which can have any desired shape and can reflect the a priori knowledge of typical road courses are subtended within the three-dimensional feature space. These surface hypotheses can include uphill slopes and downhill slopes and can generally be defined as desired. The features extracted by the backbone, or the two-dimensional feature maps, can be projected onto the surface hypotheses, so that each point on the surface hypotheses is associated with a transformed multidimensional feature. To ensure that the machine learning model remains end-to-end trainable, special transformation layers that allow a differentiable transformation can be used for the transformations. A sampling grid is used here to project the extracted features of the two-dimensional feature map onto the respective surface hypotheses, for instance. Bilinear interpolation is preferably also used to obtain a feature for each point on the surface hypotheses. FIG. 2 shows a simplified illustration of three surface hypotheses 6 that each describe different angled planes.

The feature aggregation preferably involves the calculation of intersection points of sight rays that extend from the camera through the individual voxel centers with all surface hypotheses. The number of sight rays is therefore in particular exactly the same as the number of voxel centers. The number of intersection points preferably corresponds to the product of the voxel number and the number of surface hypotheses. Preferably only the intersection points located inside the three-dimensional feature space are taken into consideration in the further process. FIG. 2 shows the three-dimensional feature space 3 according to embodiment examples of the present invention in the form of a cuboid grid. Within the three-dimensional feature space 3, the shown surface hypotheses 6 are in particular subtended as angled planes. The sight rays 7 and the respective intersection points 8 with the surface hypotheses 6 for three different voxel centers are depicted in FIG. 2 as crosses. In the next step, distances between the intersection points 8 along the sight ray 7 and the respective voxel centers are preferably calculated for each sight ray 7. The multidimensional features associated with the intersection points 8 can then be weighted based on this, wherein a large distance preferably results in a small weight. In a further step, the weighted features are then preferably added along their sight ray 7 to form a a weighted multidimensional feature for the associated voxel. The respective weight of an intersection point 8 advantageously functions here in particular as a balance between the geometric position of the extracted feature relative to the associated voxel 4 and a feature quality of the intersection point 8. In a further step, each voxel feature can additionally be weighted by a geometric a priori weight. The weight is calculated using a minimum distance between a voxel 4 along the respective sight ray and a surface hypothesis 6, for example, wherein a distance of zero achieves the highest weight of 1. The smallest weight here, for instance, is the number 0. In summary, the outlined steps result in particular in a three-dimensional feature space 3 in which every voxel 4 is uniquely described by a 3D coordinate and a weighted aggregated multidimensional feature.

Once spatial line features are represented in the resulting three-dimensional feature space, these three-dimensional features can be combined or selected in a variety of ways to be further processed for detection by a subsequent detection head. There are a variety of options for providing the three-dimensional features to the detection head. One option is to simply combine the features along a height dimension of the three-dimensional feature space. The features can be concatenated or accumulated, for example. Another option is to select the features from the three-dimensional feature space such that features are selected along the surface profile of the road surface. A method for modeling and learning this surface in the feature space in the form of a geometric representation is described in the following:

According to embodiment examples, one aspect of the present invention is learning the surface profile via a discrete probability distribution along the height dimension. This can be implemented with a machine learning model, which is based on training using an implicit learning method (self-supervised) or also using an explicit learning method (supervised). For this purpose, each voxel column 11 of the three-dimensional feature space 3 can be viewed as a classification problem. For further processing, a single optimal voxel 4 in each voxel column 11 is preferably classified for the feature provision, whereby the height dimension of the three-dimensional feature space 3 can be reduced to size 1.

Minimizing a 3D detection cost function makes it possible to adjust the weightings of the machine learning model during training such that the resulting probability distribution reflects the elevation profile of the true road surface 5. The road surface 5 can thus be learned implicitly. For the calculation of the surface probability, a probability value W which represents a probability that the road surface 5 passes through the respective voxel 4 can be estimated for each voxel 4 in a voxel column 11. This results in particular in a probability distribution along an elevation H for each voxel column 11 (see FIG. 3, right side). The voxel 4 that exhibits the highest probability within the voxel column 11 is preferably selected in a next step for feature provision (see FIG. 3, right side). Applying this classification to each voxel column 11 in particular creates a new feature map with the dimensions of the xy-plane of the three-dimensional feature space 3 that includes the most valuable features of the three-dimensional feature space 3—corresponding to the surface profile. This feature map can then be encoded by a coding block which comprises multiple convolutional neural layers. The classification problem along the voxel columns 11 can likewise be optimized by explicit supervised learning. An explicit cost function that is suitable for multiple classification is preferably set up for this purpose. This cost function in particular forms a part of the overall cost function that is minimized over the course of training. If no true 3D surface profiles are available for training, sparsely available true 3D line coordinates, for example, can be used to estimate the true surfaces.

As a further possible step, the three-dimensional feature map can be passed to a detection head that is responsible for the actual detection and geometry estimation of the markings and traffic lines. The present invention can be paired with any detection head. A lane detection head comprises multiple convolutional neural layers, for example, via which the newly obtained feature map can be processed. These can output parameters that describe traffic line markings using any line representation.

The above explanation of the embodiments describes the present invention solely within the scope of examples. Of course, individual features of the embodiments can be freely combined with one another, if technically feasible, without leaving the scope of the present invention.

What is claimed is:

1. A method for providing a three-dimensional feature map of a road surface, comprising the following steps:
providing a camera image, wherein the camera image includes a depiction of the road surface and results from acquisition by a camera;
extracting features of the camera image, wherein the extracted features are specific to the road surface;
defining a three-dimensional feature space, wherein the three-dimensional feature space comprises a large number of voxels;
determining at least three surface hypotheses for the road surface in the three-dimensional feature space;
projecting the extracted features onto the determined surface hypotheses;
calculating intersection points of sight rays with the determined surface hypotheses, wherein the sight rays extend from the camera through respective centers of all voxels of the large number of voxels;
assigning respective extracted features to the respective voxels, wherein the extracted feature assigned to the respective voxel results from a weighted sum of the extracted features projected onto the surface hypotheses, wherein weightings of the weighted sum correspond to a distance between a voxel center of the respective voxel and the calculated intersection points of the sight ray with the surface hypotheses; and
providing the three-dimensional feature map based on the assigned extracted features.

2. The method according to claim 1, wherein the following steps are used to ascertain a geometric representation of the road surface:
determining a probability value for each respective voxel within a respective vertical voxel column based on the assigned extracted features of each voxel, wherein the probability value represents a probability that the road surface passes through the respective voxel; and
ascertaining the geometric representation of the road surface based on the determined probability values.

3. The method according to claim 1, wherein the method further comprises the following step:
calculating a second distance between each voxel and a next one of the at least three surface hypotheses;
wherein the extracted features of each voxel are further weighted based on the calculated second distance.

4. The method according to claim 1, wherein each voxel is uniquely assigned a multidimensional feature that represents respective extracted features of the voxel, wherein every point on the surface hypotheses is associated with a multidimensional feature.

5. The method according to claim 1, wherein the projecting is carried out using a sampling grid and also using bilinear interpolation to obtain a feature for every point on the surface hypotheses.

6. The method according to claim 1, wherein the method is used in a vehicle, wherein the vehicle includes the camera, and the method further comprises the following steps:
initiating the acquisition of the camera image; and
using the provided three-dimensional feature map for at least partially automated driving of the vehicle.

7. The method according to claim 2, wherein an origin of the three-dimensional feature space lies in a Cartesian reference coordinate system of the road surface depicted by the camera image, wherein the vertical voxel columns represent a height dimension in the three-dimensional feature space.

8. A device for data processing, the device configured which is configured to provide a three-dimensional feature map of a road surface, the device configured to:
provide a camera image, wherein the camera image includes a depiction of the road surface and results from acquisition by a camera;
extract features of the camera image, wherein the extracted features are specific to the road surface;
define a three-dimensional feature space, wherein the three-dimensional feature space comprises a large number of voxels;
determine at least three surface hypotheses for the road surface in the three-dimensional feature space;
project the extracted features onto the determined surface hypotheses;
calculate intersection points of sight rays with the determined surface hypotheses, wherein the sight rays extend from the camera through respective centers of all voxels of the large number of voxels;
assign respective extracted features to the respective voxels, wherein the extracted feature assigned to the respective voxel results from a weighted sum of the extracted features projected onto the surface hypotheses, wherein weightings of the weighted sum correspond to a distance between a voxel center of the respective voxel and the calculated intersection points of the sight ray with the surface hypotheses; and
provide the three-dimensional feature map based on the assigned extracted features.

9. A non-transitory computer-readable storage medium on which is stored instructions providing a three-dimensional feature map of a road surface, the instructions, when executed by a computer, causing the computer to perform the following steps:
providing a camera image, wherein the camera image includes a depiction of the road surface and results from acquisition by a camera;
extracting features of the camera image, wherein the extracted features are specific to the road surface;
defining a three-dimensional feature space, wherein the three-dimensional feature space comprises a large number of voxels;
determining at least three surface hypotheses for the road surface in the three-dimensional feature space;
projecting the extracted features onto the determined surface hypotheses;
calculating intersection points of sight rays with the determined surface hypotheses, wherein the sight rays extend from the camera through respective centers of all voxels of the large number of voxels;
assigning respective extracted features to the respective voxels, wherein the extracted feature assigned to the respective voxel results from a weighted sum of the extracted features projected onto the surface hypotheses, wherein weightings of the weighted sum correspond to a distance between a voxel center of the respective voxel and the calculated intersection points of the sight ray with the surface hypotheses; and
providing the three-dimensional feature map based on the assigned extracted features.
